(19) United States
(12) Patent Application Publication
(10) Pub. No.: US 2011/0148837 A1
(43) Pub. Date: Jun. 23, 2011

(54) CHARGE CONTROL TECHNIQUES FOR SELECTIVELY ACTIVATING AN ARRAY OF DEVICES

(75) Inventor: Alok Govil, Santa Clara, CA (US)

(73) Assignee: Qualcomm MEMS Technologies, Inc., San Diego, CA (US)

(21) Appl. No.: 12/642,437

(22) Filed: Dec. 18, 2009

(51) Int. Cl. G09G 5/00; G02B 26/00

(52) U.S. Cl. 345/208; 359/291

(57) ABSTRACT

Methods and apparatus are described by which charge may be delivered to an array of electromechanical devices (e.g., MEMS or NEMS) driven in parallel such that only a desired number of the devices are actuated. Specific embodiments relate to visual displays implemented using interferometric modulators (IMODs). In particular, spatial half-toning techniques for achieving grayscale in such displays are described that are not characterized by the power penalty associated with conventional spatial half-toning techniques.

### BACKGROUND OF THE INVENTION

The present invention relates generally to the selective control of arrays of electromechanical devices such as, for example, interferometric modulators (IMODs). A particular class of embodiments relates to achieving grayscale in active matrix displays constructed from such devices.

Grayscale is conventionally achieved in active matrix displays constructed from MEMS devices (e.g., IMODs) using either temporal modulation or spatial half-toning. With temporal modulation, individual pixels are switched on and off at different rates to achieve desired pixel intensities. With spatial half-toning, each display pixel is constructed from an array of sub-pixels which are independently controlled. Desired pixel intensities are achieved with different ratios of sub-pixels in each pixel array being on or off. Both approaches result in additional undesirable power dissipation relative to other types of active matrix displays (e.g., liquid crystal displays or LCDs) that do not require half-toning or temporal modulation to achieve grayscale; temporal modulation because of the required continuous switching overhead (which scales at least linearly with the number of bits of grayscale resolution), and spatial half-toning because of the overhead associated with driving each sub-pixel independently (which scales roughly linearly with the number of sub-pixels). In addition, for either technique, this power dissipation overhead is further exacerbated by the switching losses resulting form lost vertical correlation in the higher resolution bit planes of the display content data.

### SUMMARY OF THE INVENTION

According to the present invention, methods and apparatus are described by which an array of electromechanical devices may be driven in parallel such that only a desired number of the devices is actuated. According to a particular class of embodiments, a display including an array of pixels is provided. Each pixel includes a plurality of sub-pixel elements. Each sub-pixel element is an electromechanical device configured to switch between two states. Each electromechanical device exhibits hysteresis in switching between the two states. Drive circuitry is coupled to each pixel and configured to drive more than one of the sub-pixel elements in the pixel in parallel. Control circuitry is configured to selectively activate the drive circuitry associated with selected ones of the pixels in the array and to thereby control an amount of charge stored in each selected pixel such that a subset of the sub-pixel elements for each selected pixel corresponding to the amount of charge actuates, thereby resulting in a corresponding pixel intensity for each of the selected pixels.

According to another class of embodiments, an electromechanical system including one or more arrays of electromechanical devices is provided. Each electromechanical device is configured to switch between two states. Each electromechanical device exhibits hysteresis in switching between the two states. Drive circuitry is coupled to each array and configured to drive more than one of the electromechanical devices in parallel. Control circuitry is configured to activate the drive circuitry and to thereby control an amount of charge stored in each array such that a subset of the electromechanical devices corresponding to the amount of charge actuates.

A further understanding of the nature and advantages of the present invention may be realized by reference to the remaining portions of the specification and the drawings.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable minor position versus applied voltage for an implementation of an interferometric modulator such as that of FIG. 1.

FIG. 4 is an illustration of a set of row and column voltages that may be used to drive an interferometric modulator display.

FIGS. 5A and 5B illustrate an example of a timing diagram for row and column signals that may be used to write a frame of display data to the 3×3 interferometric modulator display of FIG. 2.

FIGS. 6A and 6B are system block diagrams illustrating an embodiment of a visual display device comprising a plurality of interferometric modulators.

FIGS. 7A-7E are cross sectional views of various alternative implementations of an interferometric modulator.

FIG. 8 is an example of a MEMS device array implemented according to a specific embodiment of the invention.

FIGS. 9A and 9B show examples of pixel drive circuitry for use with various embodiments of the invention.

FIGS. 10A-10D illustrate successive actuation of MEMS devices using charge control according to a specific embodiment of the invention.

FIG. 11 is a graph illustrating pixel intensity versus charge for a pixel implemented in accordance with a specific embodiment of the invention.

FIG. 12 is a simplified schematic diagram of a MEMS device array implemented according to a specific embodiment of the invention.

FIG. 13 is a simplified schematic diagram of a MEMS device array implemented according to another specific embodiment of the invention.

FIG. 14 is a simplified schematic representation of a MEMS device array implemented according to yet another specific embodiment of the invention

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

According to various embodiments of the present invention, techniques and mechanisms are provided by which charge may be stored in an array of electromechanical devices driven in parallel such that only a desired number of the devices are actuated. Such electromechanical devices include, for example, microelectromechanical systems (MEMS) devices, as well as so-called nanoelectromechanical systems (NEMS) devices. Specific embodiments are described below with reference to the specific example of interferometric modulators (IMODs) and displays based on such devices. In particular, spatial half-toning techniques for achieving grayscale in such displays are described that reduce or eliminate the power penalty associated with conventional spatial half-toning techniques. However, it should be noted and will be appreciated by those of skill in the art that the techniques and mechanisms enabled by the present invention are more broadly applicable to displays constructed from other types of electromechanical devices such as, for example, IMODs, Mirrors (like DMD), MEMS shutters, MEMS transducers like microphones, ultrasonic transducers, etc. The techniques and mechanisms enabled by the present invention are also applicable to phased arrays of electromechanical devices, array based microphones, etc. Any type of display constructed from electromechanical devices which suffers from the drawbacks of temporal modulation or conventional spatial half-toning to achieve grayscale may benefit from embodiments of the present invention. More broadly still, the techniques and mechanisms described herein are applicable to other types of systems and devices constructed using arrays of electromechanical devices, and that may benefit from the ability to actuate fewer than all of the devices in such arrays. Such systems and devices include, for example, projectors, optical filters, microphones, etc.

According to a particular class of embodiments relating to IMOD displays, grayscale is achieved in a manner that at least partially mitigates the power dissipation penalties associated with previous approaches to achieving grayscale, e.g., temporal modulation or conventional spatial half-toning. According to some of these embodiments, each pixel in such a display is constructed from a plurality of sub-pixel display elements, each of which is an IMOD. The IMODs in each array of sub-pixels are driven in parallel rather than independently as with conventional spatial half-toning techniques. The amount of charge stored in the array of sub-pixel display elements via a drive circuit (which may include one or more thin-film transistor(s) or TFT(s) or other circuitry) is controlled such that only a desired number of the IMODs actuates, thereby achieving the desired pixel intensity (e.g., grayscale).

Some background on MEMS and IMODs, and IMOD displays that may be implemented in accordance with embodiments of the invention will be illustrative. MEMS include micromechanical elements, actuators, and electronics. Micromechanical elements may be created using deposition, etching, and or other micromachining processes that etch away parts of substrates and/or deposited material layers or that add layers to form electrical and electromechanical devices. One type of MEMS device is called an interferometric modulator or IMOD. As used herein, the term interferometric modulator or interferometric light modulator refers to a device that selectively absorbs and/or reflects light using the principles of optical interference. An interferometric modulator may comprise a pair of conductive plates, one or both of which may be transparent and/or reflective in whole or part and capable of relative motion upon application of an appropriate electrical signal. In a particular implementation, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

As will be discussed, embodiments of the invention may be implemented in any device that is configured to display an image, whether in motion (e.g., video) or stationary (e.g., still image), and whether textual or pictorial. More particularly, it is contemplated that embodiments of the invention may be implemented in or associated with a variety of electronic devices such as, but not limited to, mobile telephones, wireless devices, personal data assistants (PDAs), hand-held or portable computers, GPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). However, as mentioned above, embodiments of the invention are contemplated that include arrays of MEMS devices (both IMODs and other types of MEMS devices) in non-display applications, e.g., electronic switching devices, microphones, etc.

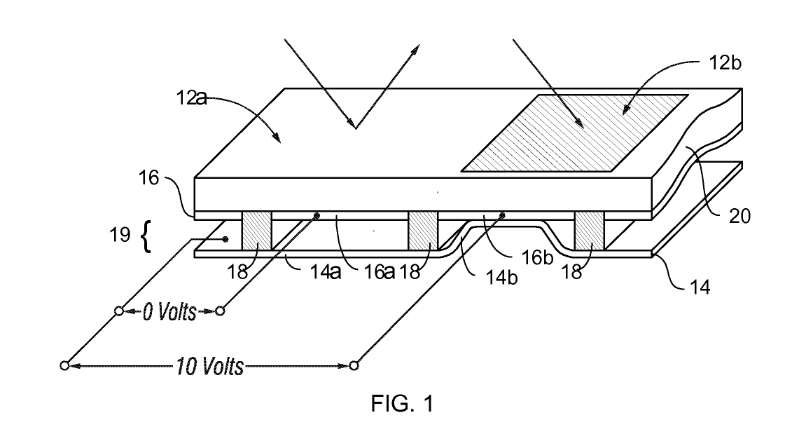

An example of two interferometric MEMS display elements is illustrated in FIG. 1. In such devices, the pixels are in either a bright or dark state. In the bright (“relaxed” or “open”) state, each display element reflects a large portion of incident visible light to a user. When in the dark (“actuated” or “closed”) state, each display element reflects little incident visible light to the user. Depending on the embodiment, the light reflectance properties of the “on” and “off” states may be reversed. MEMS pixels can also be configured to reflect predominantly at selected colors, allowing for a color display in addition to black and white.

FIG. 1 is an isometric view depicting two adjacent MEMS interferometric modulator display elements that may be used to implement specific embodiments of the invention. An interferometric modulator display implemented in accordance with such embodiments comprises a row/column array of such interferometric modulators. As will be discussed, each pixel in the display comprises an array of sub-pixels, each of which is an interferometric modulator. Each interferometric modulator includes a pair of reflective layers positioned at a variable and controllable distance from each other to form a resonant optical gap with at least one variable dimension. In the display element shown, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each element.

The depicted portion of the sub-pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. The partially reflective layer can be formed from a variety of materials that are partially reflective such as various metals, semiconductors, and dielectrics. The partially reflective layer can be formed of one or more layers of materials, and each of the layers can be formed of a single material or a combination of materials.

In some embodiments, the layers of the optical stack 16 are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) to form columns deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device. Note that FIG. 1 may not be to scale. In some embodiments, the spacing between posts 18 may be on the order of 10-100 um, while the gap 19 may be on the order of <1000 Angstroms.

With no applied voltage, the gap 19 remains between the movable reflective layer 14a and optical stack 16a, with the movable reflective layer 14a in a mechanically relaxed state, as illustrated by the sub-pixel 12a in FIG. 1. However, when a potential (e.g., voltage) difference is applied to a selected row and column, the capacitor formed at the intersection of the row and column electrodes at the corresponding sub-pixel becomes charged, and electrostatic forces pull the electrodes together. If the voltage is high enough, the movable reflective layer 14 is deformed and is forced against the optical stack 16. A dielectric layer (not illustrated in this figure) within the optical stack 16 may prevent shorting and control the separation distance between layers 14 and 16, as illustrated by actuated sub-pixel 12b on the right in FIG. 1. The behavior is the same regardless of the polarity of the applied potential difference.

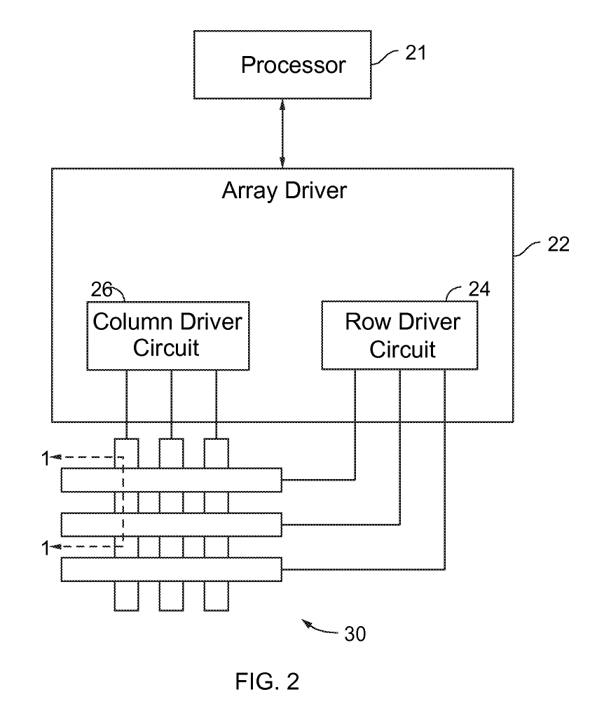

FIGS. 2 through 5 illustrate an example of a process and system that employs an array of interferometric modulators in a display application. FIG. 2 is a system block diagram illustrating an electronic device that may incorporate interferometric modulators. The electronic device includes a processor 21 which may be any general purpose single- or multi-chip microprocessor such as an ARM®, Pentium®, 8051, MIPS®, Power PC®, or ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

In one embodiment, the processor 21 is also configured to communicate with an array driver 22. In one embodiment, the array driver 22 includes a row driver circuit 24 and a column driver circuit 26 that provide signals to a display array or panel 30. The cross section of the array illustrated in FIG. 1 is shown by the lines 1-1 in FIG. 2. Note that although FIG. 2 illustrates a 3×3 array of interferometric modulators for the sake of clarity, the display array 30 may contain a very large number of interferometric modulator display elements, and may have a different number of interferometric modulators in rows than in columns (e.g., 300 pixels per row by 190 pixels per column).

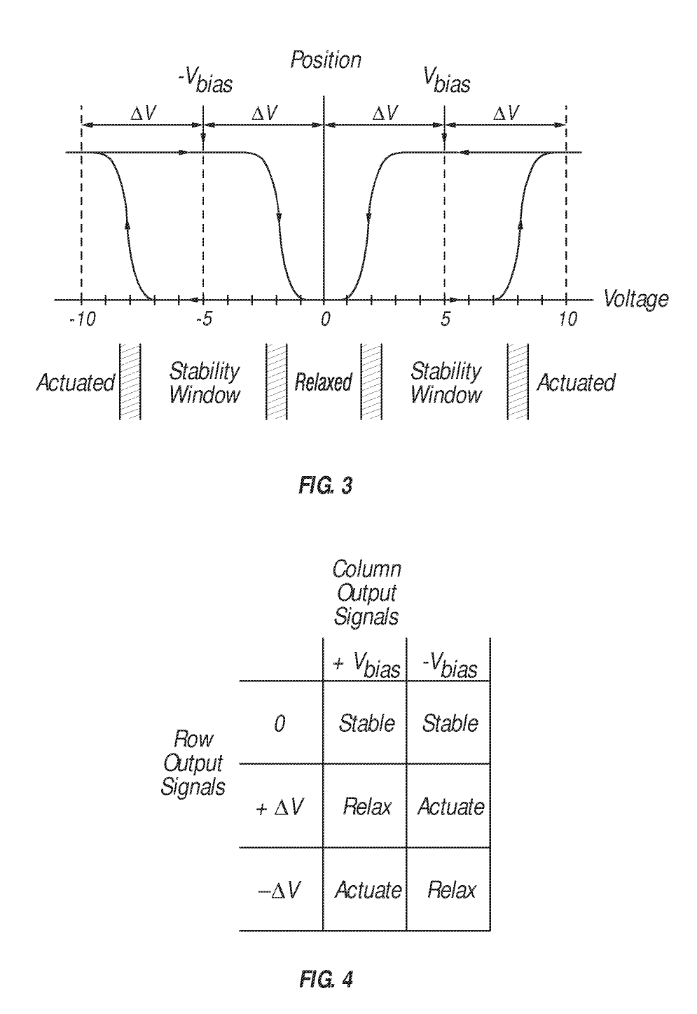

FIG. 3 is a diagram of movable mirror position versus applied voltage for an implementation of an interferometric modulator such as the one shown in FIG. 1. For MEMS interferometric modulators, the row/column actuation protocol may take advantage of a hysteresis property of these devices as illustrated in FIG. 3. An interferometric modulator may require, for example, a 10 volt potential difference to cause a movable layer to deform from the relaxed state to the actuated state. However, because of the hysteresis of the device, when the voltage is reduced from that value, the movable layer maintains its state as the voltage drops back below 10 volts. In the implementation of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state or bias voltage difference of about 5 volts such that they remain in whatever state the row strobe put them in. After being written, each pixel sees a potential difference within the “stability window” of 3-7 volts in this example. This feature makes the pixel stable under the same applied voltage conditions in either an actuated or relaxed pre-existing state. Since each interferometric modulator, whether in the actuated or relaxed state, is essentially a capacitor formed by the fixed and moving reflective layers, this stable state can be held at a voltage within the hysteresis window with almost no power dissipation. Essentially no current flows into the interferometric modulator if the applied potential is fixed.

As described further below, in typical applications, a frame of an image may be created by sending a set of data signals (each having a certain voltage level) across the set of column electrodes in accordance with the desired set of actuated pixels in the first row. A row pulse is then applied to a first row electrode, actuating the pixels corresponding to the set of data signals. The set of data signals is then changed to correspond to the desired set of actuated pixels in a second row. A pulse is then applied to the second row electrode, actuating the appropriate pixels in the second row in accordance with the data signals. The first row of pixels are unaffected by the second row pulse, and remain in the state they were set to during the first row pulse. This may be repeated for the entire series of rows in a sequential fashion to produce the frame. Generally, the frames are refreshed and/or updated with new image data by continually repeating this process at some desired number of frames per second. A wide variety of protocols for driving row and column electrodes of pixel arrays to produce image frames may be used.

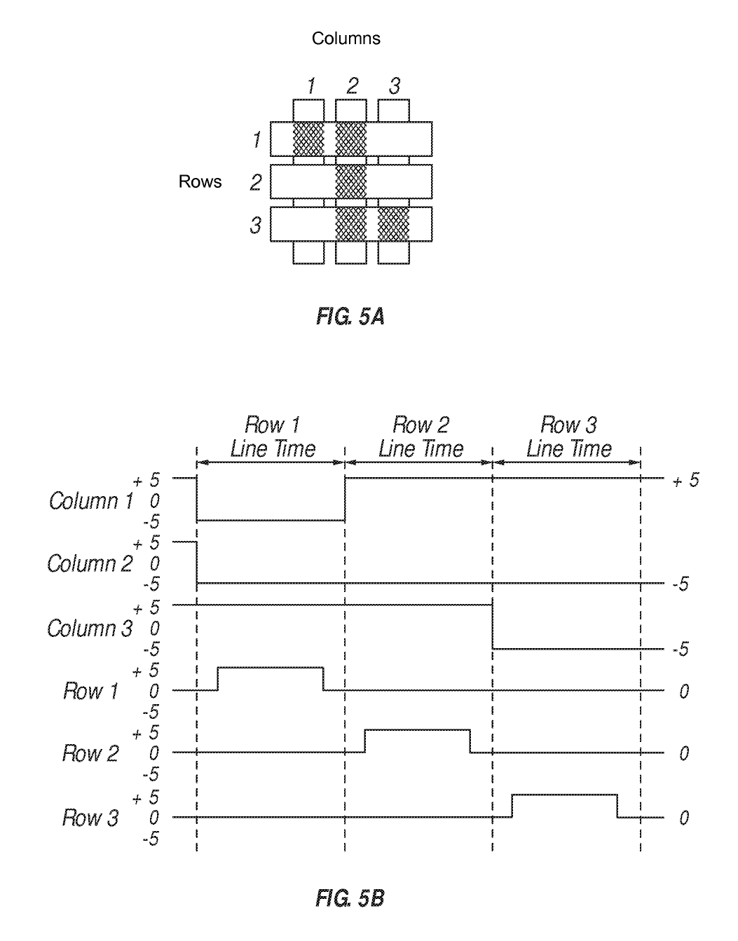

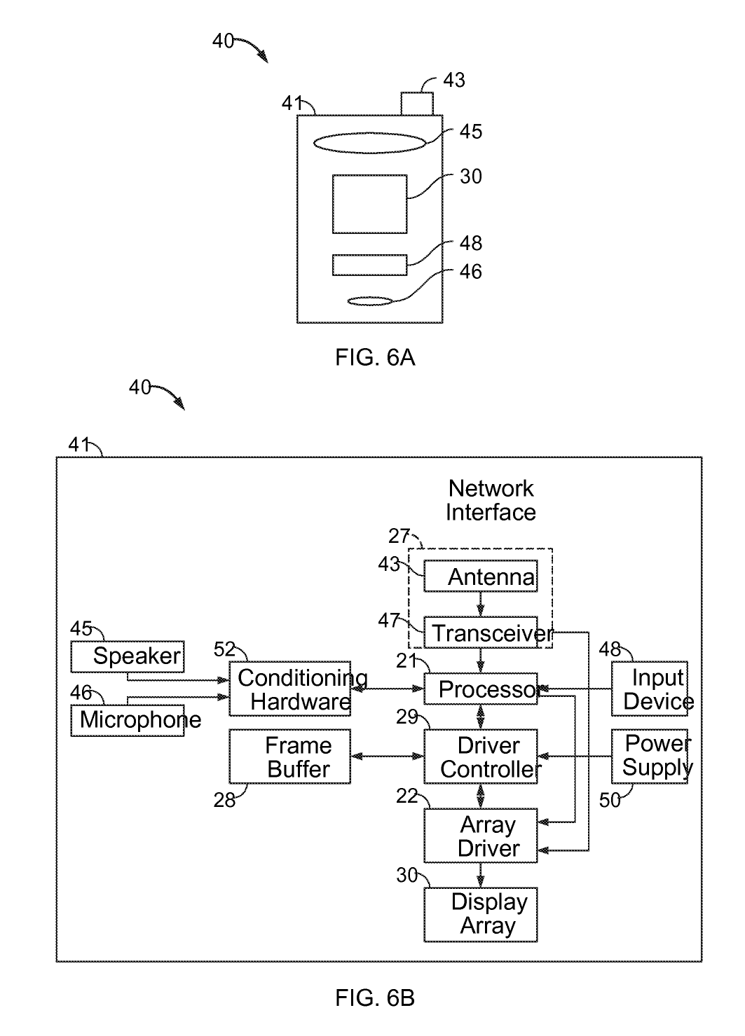

FIGS. 4 and 5 illustrate one possible actuation protocol for creating a display frame on the 3×3 array of FIG. 2. In the example illustrated, each pixel is described as if it is implemented with a single interferometric modulator. However, generalization of this description to embodiments of the invention in which each pixel comprises an array of sub-pixel elements will be understood by those of skill in the art. FIG. 4 illustrates a possible set of column and row voltage levels that may be used for pixels exhibiting the hysteresis curves of FIG. 3. In FIG. 4, actuating a pixel involves setting the appropriate column to −V_{bias}, and the appropriate row to +ΔV, which may correspond to −5 volts and +5 volts respectively Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are initially at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. The same procedure can be employed for arrays of dozens or hundreds of rows and columns. As will be discussed, the timing, sequence, and levels of voltages used to perform row and column actuation may vary widely within the general principles outlined above to achieve selective actuation of sub-pixels within each pixel according to the various display-related embodiments of the invention.

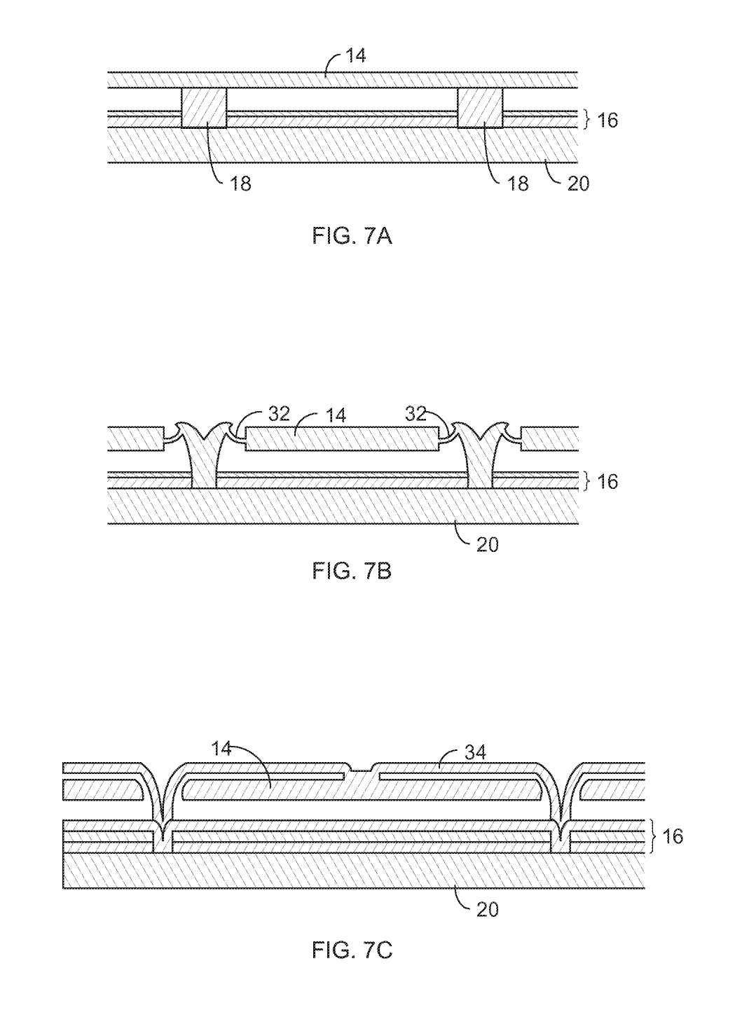

FIGS. 6A and 6B are system block diagrams illustrating an example of a display device 40 in which display-related embodiments of the invention may be implemented. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device. According to a specific class of embodiments, the display 30 includes an interferometric modulator display.

The components of display device 40 are schematically illustrated in FIG. 6B. The illustrated display device 40 includes a housing 41 and can include additional components at least partially enclosed therein. For example, the display device 40 may include a network interface 27 that includes an antenna 43 which is coupled to a transceiver 47. The transceiver 47 is connected to a processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 provides power to all components as required by the particular display device 40 design.

The network interface 27 includes the antenna 43 and the transceiver 47 so that the display device 40 can communicate with one or more devices over a network. The network interface 27 may also have some processing capabilities to relieve requirements of the processor 21. The antenna 43 may be any of a wide variety of antenna for transmitting and receiving signals. The antenna may transmit and receive RF signals, for example, according to the IEEE 802.11 standard, including IEEE 802.11(a), (b), or (g). Alternatively, the antenna may transmit and receive RF signals according to the BLUETOOTH standard. In the case of a cellular telephone, the antenna may be designed to receive CDMA, GSM, AMPS, W-CDMA, or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the display device 40 via the antenna 43.

In an alternative implementation, the transceiver 47 can be replaced by a receiver. In yet another alternative implementation, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and grayscale level.

The processor 21 includes a microcontroller, CPU, or logic unit to control operation of the display device 40. Conditioning hardware 52 generally includes amplifiers and filters for transmitting signals to the speaker 45, and for receiving signals from the microphone 46. Conditioning hardware 52 may be discrete components within the display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. For example, they may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y array of pixels.

The driver controller 29, array driver 22, and display array 30 are appropriate for any of the types of displays described herein. According to a display-related class of embodiments, driver controller 29 and array driver 22 are configured to drive the display array in accordance with these embodiments of the invention, including as described below. According to some embodiments, a driver controller 29 is integrated with the array driver 22. Such embodiments are suitable, for example, in highly integrated systems such as cellular phones, watches, and other small area displays. In yet other embodiments, display array 30 is a typical display array or a bi-stable display array (e.g., a display including an array of interferometric modulators).

The input device 48 allows a user to control the operation of the display device 40. Input device 48 may include, for example, a keypad (e.g., a QWERTY keyboard or a telephone keypad), one or more buttons, one or more switches switches, a touch-sensitive screen, a pressure- or heat-sensitive membrane, etc. Microphone 46 is an input device for the display device 40. When the microphone 46 is used to input data to the device, voice commands may be provided by a user for controlling operations of the display device 40.

Power supply 50 can include a variety of energy storage devices as are well known in the art. For example, power supply 50 may be a rechargeable battery (such as a nickel-cadmium battery or a lithium ion battery), a renewable energy source, a capacitor, or a solar cell, (including a plastic solar cell and solar-cell paint). Power supply 50 may also be configured to receive power from a wall outlet.

In some implementations control programmability resides in a driver controller which can be located in several places in the electronic display system. In some cases control programmability resides in the array driver 22. As will be appreciated, various of the functionalities and/or optimizations described herein may be implemented in any number of hardware and/or software components and in various configurations.

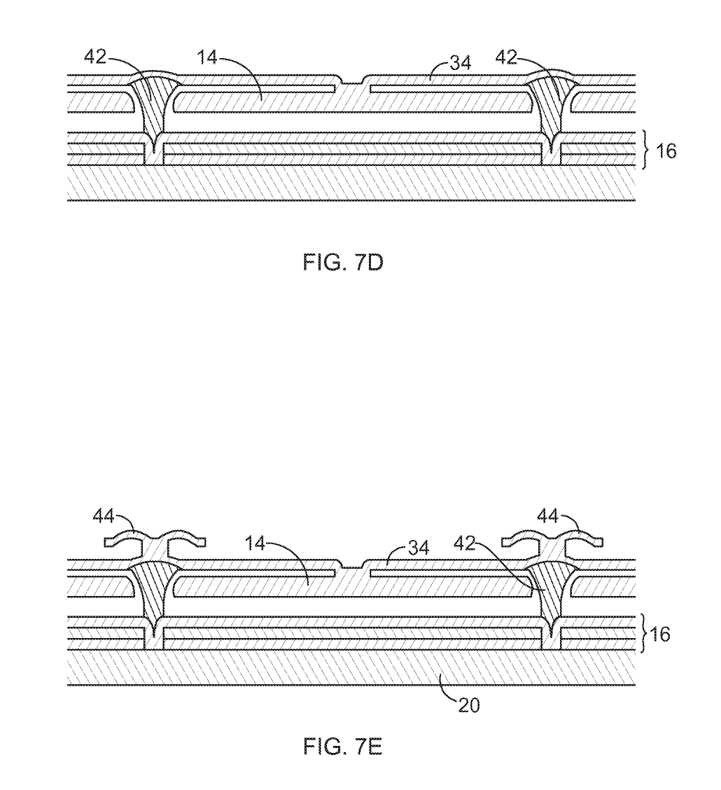

The details of the structure of interferometric modulators that operate in accordance with the principles set forth above may vary widely in accordance with various embodiments of the invention. For example, FIGS. 7A-7E illustrate five different implementations of the movable reflective layer 14 and its supporting structures. FIG. 7A is a cross section of the MEMS devices of FIG. 1, where a strip of metal material 14 is deposited on orthogonally extending supports 18. In FIG. 7B, the moveable reflective layer 14 of each interferometric modulator is square or rectangular in shape and attached to supports at the corners only, on tethers 32. In FIG. 7C, the moveable reflective layer 14 is square or rectangular in shape and suspended from a deformable layer 34, which may comprise a flexible metal. The deformable layer 34 connects, directly or indirectly, to the substrate 20 around the perimeter of the deformable layer 34. These connections are herein referred to as support posts. The implementation illustrated in FIG. 7D has support post plugs 42 upon which the deformable layer 34 rests. The movable reflective layer 14 remains suspended over the gap, as in FIGS. 7A-7C, but the deformable layer 34 does not form the support posts by filling holes between the deformable layer 34 and the optical stack 16. Rather, the support posts are formed of a planarization material, which is used to form support post plugs 42. The implementation illustrated in FIG. 7E is based on the implementation shown in FIG. 7D, but may also be adapted to work with any of the implementations illustrated in FIGS. 7A-7C as well as additional implementations not shown. In the implementation shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In implementations such as those shown in FIG. 7, the interferometric modulators function as direct-view devices, in which images are viewed from the front side of the transparent substrate 20, the side opposite to that upon which the modulator is arranged. In these implementations, the reflective layer 14 optically shields the portions of the interferometric modulator on the side of the reflective layer opposite the substrate 20, including the deformable layer 34. This allows the shielded areas to be configured and operated upon without negatively affecting the image quality. For example, such shielding allows the bus structure 44 in FIG. 7E, which provides the ability to separate the optical properties of the modulator from the electromechanical properties of the modulator, such as addressing and the movements that result from that addressing. This separable modulator architecture allows the structural design and materials used for the electromechanical aspects and the optical aspects of the modulator to be selected and to function independently of each other. Moreover, the devices shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

According to various embodiments of the invention, arrays of MEMS devices may be driven in parallel in such a manner that only a desired number of the devices actuates. According to a particular class of embodiments, this functionality may be implemented in the context of a visual display comprising an array of such devices to achieve various levels of grayscale or pixel intensity. One subset of this class of embodiments includes displays constructed from IMODs that operate in many respects as described above with reference to FIGS. 1-7E. Various examples of how such embodiments may be constructed are described below with reference to the remaining figures. However, it should again be noted that the basic principles underlying the present invention are not limited to the particular types of display element described above, or even to display applications.

According to specific embodiments of the invention, an array of IMOD devices are connected in parallel and driven by the same circuit. As will be discussed, such a circuit may comprise a single control switch, but also may be implemented with more complicated circuitry. According to specific embodiments employing a single control switch, the switch is turned on for a time period which is less than the response times of the IMOD elements, but greater than the electrical charging and discharging times (e.g., RC time constants) associated with each. Once the switch is turned off, the result is that the capacitance associated with each IMOD element stores some amount of charge. By controlling the amount of charge delivered by the switch (e.g., by varying the applied voltage or the on-time of the switch) the number of sub-pixel IMOD elements that actuates (i.e., transition from the relaxed state) may be controlled to achieve different pixel intensities.

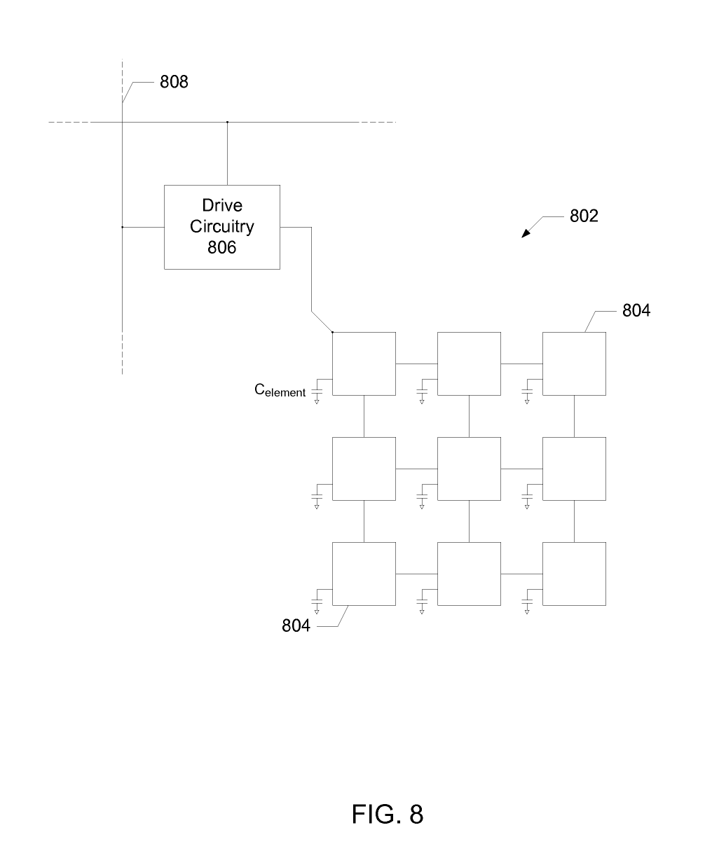

FIG. 8 illustrates an example of a pixel 802 comprising nine sub-pixel elements 804 which may be driven to achieve a desired grayscale in accordance with a specific embodiment of the invention. In this example, each sub-pixel element 804 is a MEMS device such as, for example, an IMOD. In contrast with conventional spatial half-toning techniques, the sub-pixel elements of the depicted pixel are connected and driven in parallel by the same pixel drive circuitry 806. That is the electrodes by which an actuation voltage is applied to each of the sub-pixel elements for the pixel are electrically connected such that they may collectively be driven by a single signal.

It should be noted that, for color displays, the array of sub-pixel elements driven in parallel would correspond to one of the pixel colors, e.g., red, green, or blue. That is, embodiments of the invention are contemplated in which arrays of sub-pixel elements are driven to achieve desired color intensities.

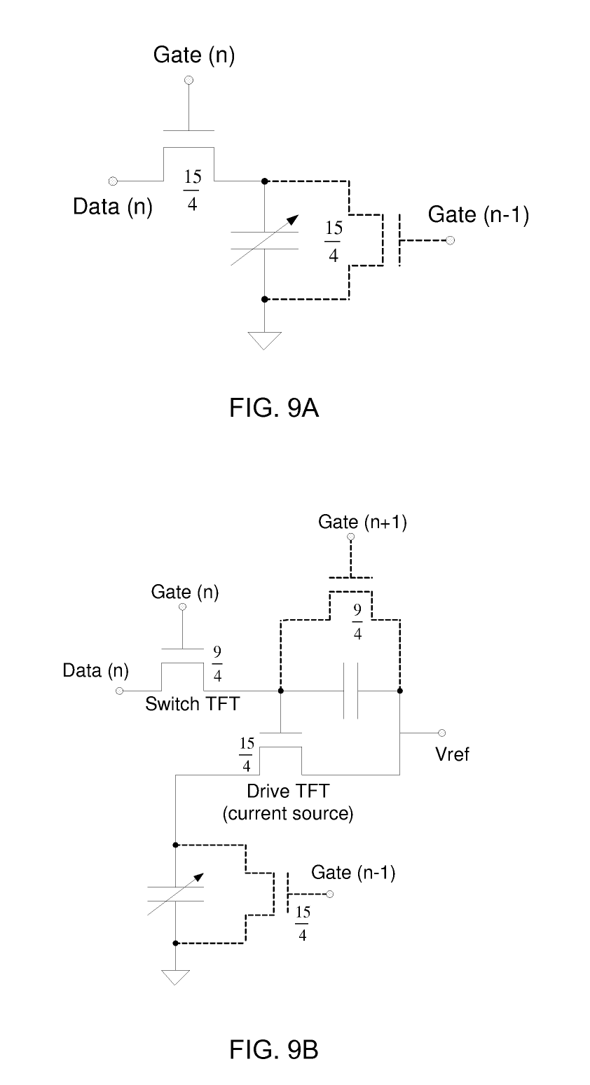

According to some embodiments, pixel drive circuitry 806 may be implemented with a single switch, e.g., a thin-film transistor (TFT) as shown in FIG. 9A. However, such an approach is based on the assumption that the switch is significantly faster than the mechanical response time of the individual MEMS devices, e.g., IMODs. If this is not the case, other circuitry may be required. For example, each pixel could be driven by a voltage-controlled current source which is not sensitive to the response time of the MEMS devices as shown in FIG. 9B. More generally, multiple switches in various configurations, higher level logic, or any other suitable circuitry may be employed to drive the sub-pixels in parallel. For example, any configuration of switches or logic conventionally used to drive a single MEMS device may be adapted to control the storage of charge in multiple MEMS devices connected in parallel in accordance with embodiments of the invention. A wide range of suitable variations are within the capabilities of those of skill in the art. Regardless of the specific nature of pixel drive circuitry 806, the desired pixel intensity, e.g., grayscale, may be achieved in the depicted embodiment with a single write operation delivered to the pixel drive circuitry via a single data line 808.

The amount of charge delivered to the array of sub-pixels during the single write operation is controlled such that only a subset of the sub-pixel elements actuates. Again referring to FIG. 8, each sub-pixel element 804 has an associated capacitance (Cₑₗₑₘₑₙₜ). As charge is delivered to the sub-pixel array, these capacitances charge up until one of the sub-pixel elements switches. At this point, the capacitance of the switched sub-pixel element increases significantly relative to the other unswitched elements (e.g., by a factor of about 10 in some embodiments). Actuation of a sub-pixel element and the corresponding change in capacitance may be understood, for example, with reference to IMODs 12a and 12b of FIG. 1. IMOD 12a is shown in the “relaxed” position with layer 14a spaced apart from corresponding optical stack 16a. By contrast, adjacent IMOD 12b is shown in the “actuated” position with layer 14a “pulled in” close to optical stack 16b. As is well known, capacitance is inversely proportional to the separation between opposing parallel conducting planes, i.e., the closer the planes, the greater the capacitance. Thus, the actuated sub-pixel element has a greater capacitance than the elements in the relaxed state.

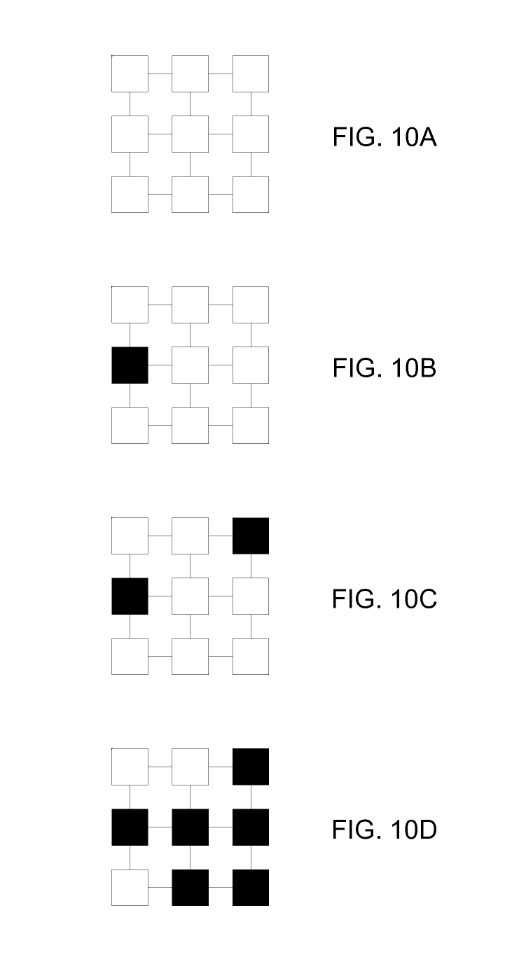

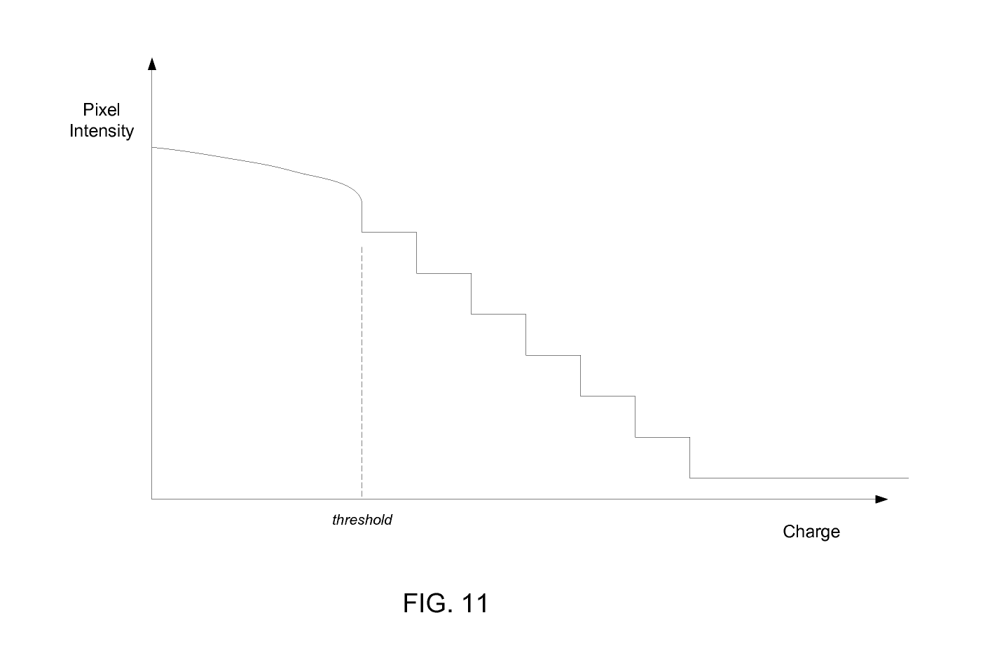

Because of the increase in capacitance of the actuated sub-pixel element, the actuated element sinks charge accumulated on the other sub-pixel elements such that they each back off from the potential required for actuation and a stability window of operation is reached (see, for example, FIGS. 3 and 11). Then, as further charge is delivered to the sub-pixel array the process is repeated until the desired number of sub-pixel elements has been actuated. This progression may be understood with reference to FIGS. 10A-10D and 11.

FIG. 10A shows an array of nine IMODs in the relaxed or reflective state. As the accumulated charge on one of the devices exceeds the switching threshold of that device (see FIG. 11), it actuates and goes to its non-reflective state (FIG. 10B). The addition of further charge causes a second IMOD to actuate (FIG. 10C), and so on until a desired number of IMODs have actuated (i.e., become non-reflective), and the desired grayscale or pixel intensity is represented (FIG. 10D). This succession of device actuation is represented in FIG. 11 by a stair-case-like curve in which each downward step represents actuation of another device and a resulting stable level of grayscale or pixel intensity. Thus, despite having multiple MEMS devices, the desired grayscale or pixel intensity may be achieved with only a single write operation.

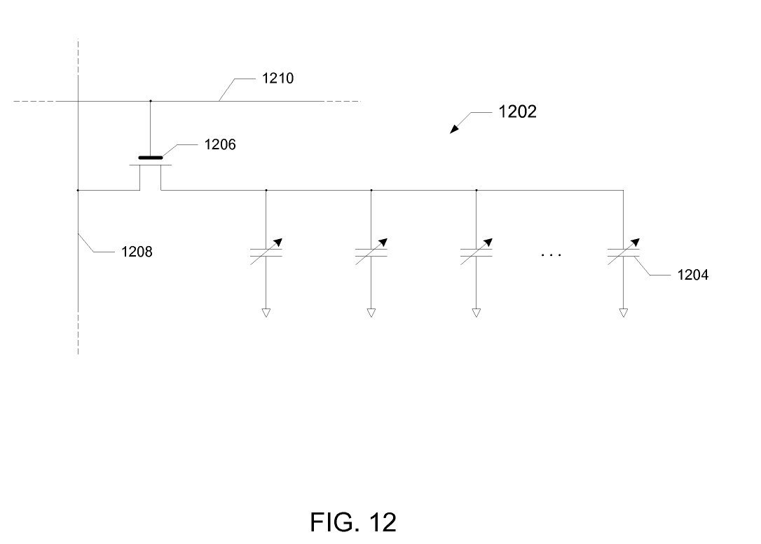

According to a subset of one class of embodiments, a particular one of which is illustrated by the simplified diagram of FIG. 12, the sub-pixel elements 1204 of a pixel 1202 are driven with a single switch 1206, e.g., a TFT, the source of which is connected to a single data line 1208, the gate of which is connected to a single gate line 1210, and the drain of which is connected to each of the electrodes of the sub-pixel elements arranged in parallel as shown. As will be understood, for embodiments in which the MEMS devices in the sub-pixel array are IMODs, connection to the drain of the TFT may be made via display column conductors spanning each sub-pixel array. The particular nature of the parallel connection will depend on the underlying MEMS device type as would readily be understood by those of skill in the art.

According to various embodiments of the invention, control of the delivery of charge to an array of sub-pixels may be achieved in a variety of ways. For example, and referring to the circuit diagram of FIG. 12, the pulse width of the gate drive for the TFT can be manipulated to achieve any desired level of charge. Such pulse width control might be provided, for example, by array driver 22 and row driver circuit 24 of FIG. 2. Alternatively, the gate pulse width can remain constant and the voltage on the data line can be manipulated to achieve the desired level of charge. Such voltage control might be provided, for example, by array driver 22 and column driver circuit 26 of FIG. 2.

The latter approach may be preferred for displays in which information is written in the same dimension as the gate control. That is, for example, if content is written to the display row by row, and pixels are selected along the same axis, i.e., row by row, then each pixel in a row will see the same pulse width.

More generally, the control circuitry that provides signals to the drive circuitry at each pixel may be implemented in a wide variety of ways without departing from the invention. For example, such control circuitry could be implemented monolithically or in a distributed manner. For display applications, the control circuitry (e.g., array driver 22 of FIG. 2) would typically include column driver circuitry (e.g., circuit 26 of FIG. 2) for each column at the periphery of the array that may, for example, receive a plurality of input bits that select a particular drive voltage. For example, for an embodiment of the invention with 9-15 sub-pixel elements, sufficient grayscale control might be achieved using 3-4 bit control of such a circuit. Other numbers of bits may be used to suit a particular application as would be understood by those of skill in the art. The control circuitry would also typically include row driver circuitry (e.g., circuit 24 of FIG. 2) at the periphery of the array to select each row for writing content delivered via the column driver circuitry.

According to some embodiments, the order in which the sub-pixel elements in a given pixel actuate as charge is delivered may occur randomly from pixel to pixel, depending on device variations resulting from manufacturing tolerances and the like. As will be understood, such variations may be quite small resulting, for example, from process variations and tolerances during fabrication. For example, any device variations that result in different “pull in” voltages within an array of IMODs, i.e., the voltage at which the movable layer pulls in to the optical stack, could determine the order of actuation. For example, the spring constant of various MEMS devices may be different. This is generally caused by variation in stresses in the mechanical layers of the MEMS devices. In another example, the offset voltages of various MEMS devices may be different. This is generally caused by charge trapping within the device, which is further dependent on the past charge levels with which each device was driven. A wide variety of other variations are contemplated within the scope of the invention.

According to other embodiments, the order in which the sub-pixel elements in a given pixel actuate may be controlled using a variety of mechanisms. According to these embodiments, structural mechanisms or features are introduced and/or manipulated within a pixel to provide a predictable distribution of the types of variation that determine the order of actuation. For example, according to some of these embodiments, some mechanical or physical asymmetry is introduced in the MEMS devices in the sub-pixel array and controlled to effect a predictable actuation sequence (e.g., the relative sizes or areas of IMODs, the spring constant associated with each, etc.).

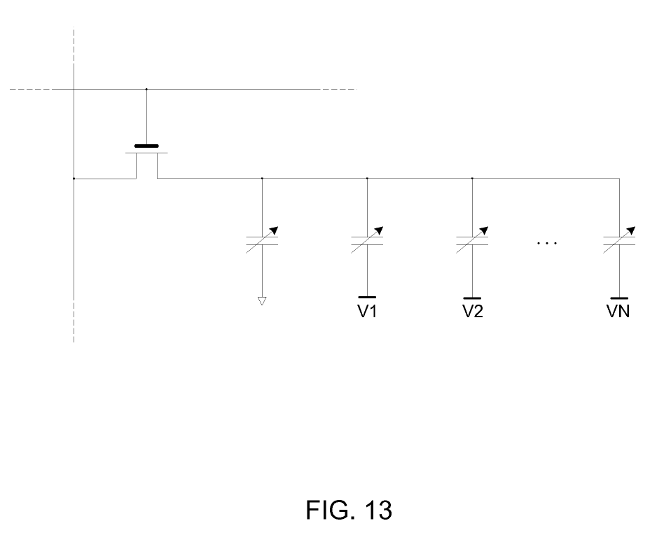

According to another example illustrated in FIG. 13, different sub-pixel elements within an array are connected to different reference voltages. As shown in the figure, a first sub-pixel element (which may be one or more) is connected to ground, a second element (which may be one or more) to reference voltage V1, a third element (which may be one or more) to V2, and so forth. Thus, for example, if all of the devices have an actuation bias voltage of 10.0 volts, and V1=0.1 volts, V2=0.2 volts, etc., some will actuate when the bias voltage applied to the array is 10.0, more when it is 10.1, even more when it is 10.2, and so on.

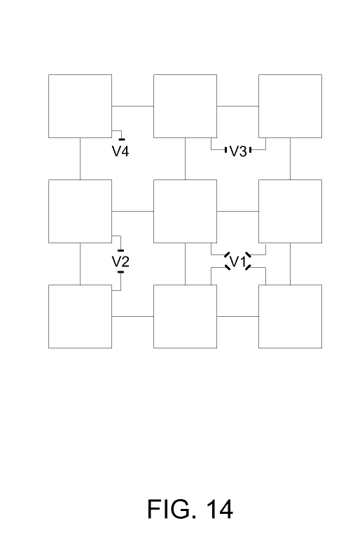

Embodiments similar to the example shown in FIG. 13 may be implemented in which there are as many reference voltages as there are sub-pixel elements in a pixel. Alternatively, embodiments may use fewer reference voltages, by grouping some sub-pixel elements together. FIG. 14 shows an example of a way in which the sub-pixel elements in such an embodiment might be grouped into subsets to achieve various levels of grayscale. In the implementation depicted, 4 adjacent sub-pixel elements are grouped together in one subset, with additional subsets of 2, 2, and 1 elements. By connecting the different subsets to different reference voltages, the different subsets may be actuated in a controlled manner to achieve desired levels of grayscale or pixel intensity.

Such reference voltages may be introduced using a variety of mechanisms. For example, each reference voltage could be introduced via its own conductive plane. Alternatively, all of the reference voltages could be derived relative to the same plane, e.g., the ground plane, with additional circuit elements (e.g., voltage dividers, voltage regulators, etc.) interposed between the device electrodes and the plane. A wide variety of mechanisms for achieving different reference voltages may be employed without departing from the scope of the invention.

As will be appreciated with reference to the foregoing description, display applications may benefit from embodiments of the invention in that a desired level of grayscale or pixel intensity may be achieved in a single step, e.g., write operation. This represents a significant power savings relative to techniques which drive sub-pixels independently, thus requiring multiple steps to achieve the same result. In addition, the power penalty associated with lost vertical correlation in content data is not exacerbated by the need to drive sub-pixels independently as with conventional spatial half-toning techniques. That is, fewer write steps also means that the power dissipation resulting from lost vertical correlation in the content data is comparable to displays which don't require temporal modulation or spatial half-toning to achieve grayscale.

While the invention has been particularly shown and described with reference to specific embodiments thereof, it will be understood by those skilled in the art that changes in the form and details of the disclosed embodiments may be made without departing from the spirit or scope of the invention. For example, as discussed above, specific embodiments are described herein in the context of visual displays based on IMODs. However, the scope of the present invention is not so limited. Rather, it includes visual displays based on a much wider range of MEMS and NEMS devices, e.g., any type of MEMS or NEMS device on which a display might be based, and which switches between two stable states in a manner characterized by hysteresis. Still more generally, embodiments of the present invention are contemplated that may be implemented in applications that relate to arrays of MEMS or NEMS devices, but that are not related to visual displays. Such applications include, but are not limited to, filters, sensors, arrays of MEMS audio speaker elements (e.g., to emulate the movement of an analog speaker cone), microphone arrays, etc.

In another example, and notwithstanding descriptions herein regarding the delivery of charge to an array of electromechanical devices, embodiments of the invention are contemplated in which selective actuation of a subset of devices in an array of devices driven in parallel is achieved by instead removing previously stored charge from at least some of the devices. As long as a single write operation results in the desired amount of charge distributed among the parallel devices, such embodiments are within the scope of the invention.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A display, comprising:
an array of pixels, each pixel comprising a plurality of sub-pixel elements, each sub-pixel element comprising an electromechanical device configured to switch between two states, each electromechanical device exhibiting hysteresis in switching between the two states;
drive circuitry coupled to each pixel and configured to drive more than one of the sub-pixel elements in the pixel in parallel; and
control circuitry configured to selectively activate the drive circuitry associated with selected ones of the pixels in the array and to thereby control an amount of charge stored in each selected pixel such that a subset of the sub-pixel elements for each selected pixel corresponding to the amount of charge actuates, thereby resulting in a corresponding pixel intensity for each of the selected pixels.

2. The display of claim 1 wherein each electromechanical device comprises an interferometric modulator (IMOD).

3. The display of claim 1 wherein the sub-pixel elements in each of the selected pixels actuate in an order determined by device variations resulting from manufacturing tolerances.

4. The display of claim 1 wherein the subset of sub-pixel elements in each of the selected pixels are configured to actuate in a predetermined order.

5. The display of claim 4 wherein at least one physical parameter of each of the sub-pixel elements is configured to cause actuation in the predetermined order.

6. The display of claim 5 wherein the at least one physical parameter comprises one or more of device area or device spring constant.

7. The display of claim 4 wherein the sub-pixel elements in each of the pixels are connected to a plurality of different reference voltages that determine, at least in part, the predetermined order.

8. The display of claim 1 wherein the control circuitry and the drive circuitry are configured to store the amount of charge for each selected pixel by varying a voltage applied to each of the selected pixels.

9. The display of claim 1 wherein the control circuitry and the drive circuitry are configured to store the amount of charge for each selected pixel by varying a width of a pulse applied to each of the selected pixels.

10. An electromechanical system, comprising:
one or more arrays of electromechanical devices, each electromechanical device being configured to switch between two states, each electromechanical device exhibiting hysteresis in switching between the two states;
drive circuitry coupled to each array and configured to drive more than one of the electromechanical devices in parallel; and
control circuitry configured to activate the drive circuitry and to thereby control an amount of charge stored in each array such that a subset of the electromechanical devices corresponding to the amount of charge actuates.

11. The electromechanical system of claim 10 wherein each electromechanical device comprises an interferometric modulator (IMOD).

12. The electromechanical system of claim 10 wherein the electromechanical devices actuate in an order determined by device variations resulting from manufacturing tolerances.

13. The electromechanical system of claim 10 wherein the electromechanical devices are configured to actuate in a predetermined order.

14. The electromechanical system of claim 13 wherein at least one physical parameter of each of the electromechanical devices is configured to cause actuation in the predetermined order.

15. The electromechanical system of claim 14 wherein the at least one physical parameter comprises one or more of device area or device spring constant.

16. The electromechanical system of claim 13 wherein the electromechanical devices are connected to a plurality of different reference voltages that determine, at least in part, the predetermined order.

17. The electromechanical system of claim 10 wherein the control circuitry and the drive circuitry are configured to store the amount of charge by varying a voltage applied to the array of electromechanical devices.

18. The electromechanical system of claim 10 wherein the control circuitry and the drive circuitry are configured to store the amount of charge for each selected pixel by varying a width of a pulse applied to the array of electromechanical devices.

19. The electromechanical system of claim 10 wherein the electromechanical system comprises one of the group consisting of a display, a filter, a projector, a microphone, or a speaker.
